(19) United States
(12) Patent Application Publication
(10) Pub. No.: US 2026/0003036 A1
(43) Pub. Date: Jan. 1, 2026

(54) Method for Determining an Integrity Range of a Parameter Estimation for Localizing a Vehicle

(71) Applicant: Robert Bosch GmbH, Stuttgart (DE)

(72) Inventors: Carsten Hasberg, Ilsfeld-Auenstein (DE); Daniel Zaum, Sarstedt (DE); Pierre Lothe, Hildesheim (DE); Arun Das, San Jose, CA (US); Jan Rohde, Stuttgart (DE); Thomas Ulrich, Ilsfeld (DE); Michael Baus, Bietigheim-Bissingen (DE)

(21) Appl. No.: 18/880,672

(22) PCT Filed: Jun. 23, 2023
(86) PCT No.: PCT/EP2023/067095

§ 371 Date: Jan. 2, 2025

(30) Foreign Application Priority Data
Jul. 12, 2022 (DE) 10 2022 207 090.9

(51) Int. Cl. G01S 7/40; G01S 13/88

(52) U.S. Cl. CPC G01S 7/40; G01S 13/88

(57) ABSTRACT

A method is disclosed for determining an integrity range of a parameter estimation for localization of a vehicle on the basis of obtained sensor data for localization according to surroundings features, wherein the integrity range describes the range in which an estimated parameter is located with a minimum probability. The method includes (i) determining a base integrity information item, (ii) determining at least one additional integrity information item, and (iii) determining the integrity range using the base integrity information item and the at least one first additional integrity information item.

The invention relates to a method for determining an integrity range of a parameter estimation for localization of a vehicle on the basis of obtained sensor data for localization according to surroundings features. Furthermore, a computer program for carrying out the method, a machine-readable storage medium on which the computer program is stored, and a control unit for a motor vehicle are specified, the control unit being configured to carry out the method. In particular, the method can be used in the field of at least partially automated or autonomous driving.

### PRIOR ART

One of the most important challenges for autonomous driving is determining the self-position of the autonomous vehicle as accurately and reliably as possible. The autonomous vehicle generally has sensors, such as inertial sensors, wheel sensors, surroundings sensors, GNSS sensors, optical and/or acoustic sensors, by means of which the vehicle can estimate its self-position.

From GNSS localization (GNSS sensor as primary data source), it is known that, with respect to an identified self-position, information about the (expected) estimation accuracy of said self-position can also be output. In this context, the confidence of the identified self-position can be represented by a so-called “protection level” (in short: “PL”), for example. The PL can describe a statistical error limit, the calculation of which is generally based on statistical considerations and, where appropriate, additionally on a suitable coordination of the estimation algorithms.

The concept of providing the protection level is in particular common in aerospace. However, the solutions developed in this context are not readily transferable to the application field of autonomous driving. In particular, street canyons in urban areas and their influence on satellite signals, for example, constitute problems that do not occur in aerospace applications.

In addition, an effort to improve at least partially automated or autonomous driving consists in replacing the GNSS signals as the primary data source for localization with sensor data from surroundings sensors. In particular, the primary GNSS localization is to be replaced with primary localization according to known surroundings features (so-called feature localization), particularly for localization tasks in certain areas, such as urban areas.

It is also desirable to be able to provide as reliable information as possible about the (expected) estimation accuracy of such feature-based localization methods.

### DISCLOSURE OF THE INVENTION

Here, according to claim 1, a method for determining an integrity range of a parameter estimation for localization of a vehicle on the basis of obtained sensor data for localization according to surroundings features is proposed, wherein the integrity range describes the range in which an estimated parameter is located with a minimum probability, the method comprising at least the following steps:
a) determining a base integrity information item,
b) determining at least one additional integrity information item,
c) determining the integrity range using the base integrity information item and the at least one first additional integrity information item.

For example, steps a), b), and c) can be performed at least once and/or repeatedly in the sequence indicated in order to perform the method. Furthermore, steps a), b), and c), in particular steps a) and b), can be performed at least partially in parallel or simultaneously. For example, the method can be performed by a control unit described herein. For example, the vehicle can be a motor vehicle, e.g. an automobile. The vehicle is preferably configured for at least partially automated or autonomous driving operation. The method advantageously contributes to providing a protection level calculation for a feature localization.

The integrity range describes the range in which an estimated parameter (value) is (actually) located with a minimum probability. The estimated parameter (value) in principle describes an (individual, in particular instantaneous) estimation result of the parametric estimation. In other words, this means in particular that the integrity range describes the range in which a real or actual value of an estimated parameter is located with a minimum probability. Such an integrity range may also be referred to as the so-called “protection level.”

The minimum probability is generally a predefined minimum probability. Preferably, the minimum probability is 90%, more preferably 95%, or even 99%.

Preferably, the integrity range is a protection level. The protection level generally describes the (spatial, in particular two- or three-dimensional) range in which an estimated parameter (value) is (actually) located with a minimum probability. The estimated parameter (value) in principle describes an (individual, in particular instantaneous) estimation result of the parametric estimation. In other words, this means in particular that the protection level describes the range in which a real or actual value of an estimated parameter is located with a minimum probability.

In yet other words, a protection level, in particular, describes a confidence interval or a (spatial) confidence range in which the true value of an estimated parameter is located with a minimum probability. The estimated value of the parameter is usually in the middle or the center of the confidence interval or confidence range.

The minimum probability with which a real or actual value of an estimated parameter is actually located in a protection level is still much higher than in “usual” integrity ranges. The minimum probability here is typically over 99.99%, particularly preferably over 99.999%, or even over 99.9999%. For the protection level, the minimum probability may also be expressed not in percent but in possible errors during a particular time interval. A protection level may, for example, be defined such that the parameter in question is outside the protection level at most once in 10 years. The protection level may, for example, be expressed either as a unitless probability or as a rate, i.e., as a probability of errors occurring over a time interval.

Preferably, the method is for determining an integrity range of a parameter estimation of a driving operating parameter of a motor vehicle. The driving operating parameter is generally a safety-critical or safety-relevant parameter of the driving operation of a motor vehicle. Preferably, the driving operating parameter is a (safety-critical or safety-relevant) parameter of the driving operation of a motor vehicle operating (or operated) with at least partial automation or even autonomously.

The term “driving operating parameter” is in particular understood herein to mean a parameter that helps to describe the spatial driving operation of a motor vehicle or the operation of a motor vehicle in space. In particular, the driving operating parameter at least helps to describe self-movement and/or self-position of a motor vehicle. The driving operating parameter may, for example, be a (self-)position, a (self-)speed, (self-)acceleration, or a situation (or orientation) of the motor vehicle. Preferably, the driving operating parameter is a self-position of the motor vehicle.

Preferably, the method is for determining an integrity range describing the integrity of an estimation of a self-position of a vehicle. In other words, this means in particular that the parameter is preferably a self-position of a vehicle. For example, the method may (thus) serve to determine an integrity range of a position estimation of a vehicle position. In this respect, the integrity range may describe the range in which an estimated self-position of a vehicle is (actually) located with a minimum probability. Alternatively or in addition to the estimation of the self-position of the vehicle, the method may also be used for the estimation of the self-speed, orientation, self-movement, or the like of the vehicle.

The parameter estimation may generally comprise one or more methods for estimating a (the same) parameter. For example, the parameter estimation may comprise at least two methods different from one another, such as a first method and a second method different from the first method, for estimating the parameter. Preferably, methods for estimating the parameter are used which may moreover also provide and/or determine an integrity information item regarding the integrity of the estimation.

The method may preferably be used when the vehicle is in certain areas where, for example, comparatively poor GNSS reception is to be expected. “GNSS” means Global Navigation Satellite System. For example, the method may be performed when the vehicle is in an urban area.

According to an advantageous embodiment, it is proposed that the localization is performed according to surroundings features as positioning relative to known features in the surroundings of the vehicle. For example, the known features may be taken from a digital map of the surroundings of the vehicle. In particular, in connection with the method described herein, feature-based localization (feature localization) is used as the primary localization method. This “primary” localization method may generally be supplemented by secondary localization methods, such as inertial navigation or (simplified) GNSS localization. An advantage of the application may be, for example, that the vehicle can be equipped with comparatively cheaper GNSS receivers.

According to another advantageous embodiment, it is proposed that the sensor data is obtained from a camera sensor, video sensor, radar sensor, or lidar sensor. These sensors are particularly advantageous for performing a feature-based localization of a vehicle. One or more of the sensors may be disposed in or on the vehicle.

According to another advantageous embodiment, it is proposed that at least one result of the parameter estimation and the base integrity information item are determined by a filter. The filter used may be, for example, a Kalman filter or a particle filter. Preferably, a Kalman filter may be used. The Kalman filter can read in sensor data that is suitable for feature-based localization. The Kalman filter typically outputs not only the estimated localization result but also at least one stochastic indication (e.g., in the form of a covariance matrix) which mathematically describes the reliability of the estimation result.

According to another advantageous embodiment, it is proposed that the base integrity information item is determined on the basis of a mathematical model and/or describes a stochastic measure. In particular, the base integrity information item describes the variance and/or information quality estimate of the (feature) localization.

For example, the base integrity information item may be determined on the basis of at least one variance and/or with data from a covariance matrix. Corresponding mathematical or stochastic information may typically be provided, for example, by a Kalman filter with respect to a particular position result.

According to another advantageous embodiment, it is proposed that the at least one additional integrity information item describes information about the number and/or distribution (and/or density) of the detectable features. Preferably, at least the number of features is also involved, as an additional integrity information item, in the calculation of the integrity range. For example, a Fisher distribution (with the number of features as parameter) may be specified or used, in particular in order to scale the base integrity information item (for example, variance/information quality estimate).

In particular, the at least one additional integrity information item may (further) describe at least one information item about the distribution of the detectable features. An example of a distribution of detectable features may also be, for example, periodically recurring structures, such as posts on a highway.

Advantageously, the integrity range may be determined using a stochastic measure (as the base integrity information item) and information about the distribution of the features (as the additional integrity information item).

One or more of the following information items may be used as advantageous (further) additional integrity information item(s):
state variables of the vehicle system (for example: wheel speeds, duration of operation);
number of plausible hypotheses for matching between feature measurement and feature map;
similarity value of feature measurement and feature map, in particular evaluated after matching (for example, Hausdorff metric);
periodic structures in map (for example, post of guardrail at distance of 1.5 m increases probability of selection of a false optimum in the feature matching);
additional monitoring outputs (for example, strong fluctuations in similarity values);
state variables (for example: time, initialization phase, situation estimation, . . . );
movement information (for example: position, orientation, speed).

According to another advantageous embodiment, it is proposed that the integrity range is determined as a protection level. The protection level generally describes the (spatial, in particular two- or three-dimensional) range in which an estimated parameter (value) is (actually) located with a minimum probability. Before the protection level is provided, a coordinate transformation can be performed, in particular to output the protection level in the desired form.

The protection level can advantageously make a statement about the error of the position estimation of the feature localization. Furthermore, the protection level may have a specification of how often the position estimation is less than a target value. Furthermore, it may be defined how high the probability is that a position error is greater than a defined target value without the protection level indicating this.

Optionally, the method may be combined with existing algorithms for GNSS localization. These may, for example, contribute to determining the integrity range according to step c).

According to a further aspect, a computer program for carrying out a method presented here is proposed. In other words, this relates in particular to a computer program (product) comprising instructions which, when the program is executed by a computer, prompt said computer to perform a method described herein.

Proposed according to a further aspect is a machine-readable storage medium on which the computer program proposed here is saved or stored. The machine-readable storage medium is typically a computer-readable data carrier.

According to a further aspect, a control unit for a motor vehicle is specified, the control unit being configured to carry out a method described herein. The control unit can, for example, comprise a computer or controller capable of executing instructions in order to carry out the method. For this purpose, the computer or the controller can execute the specified computer program, for example. For example, the computer or the controller can access the specified storage medium in order to be able to execute the computer program.

The control unit may, for example, be a component of a movement and position sensor, which, in particular, can be or is arranged in or on a (motor) vehicle, or may be connected to such a sensor for information exchange. In this context, it may be provided that, for example, the GNSS sensor and/or a localization device (containing the filter explained above) and/or the control unit are components of the movement and position sensor. Furthermore, it may (alternatively) be provided that the control unit comprises a movement and position sensor, which in this case may, for example, comprise the GNSS sensor and/or a localization device.

The details, features and advantageous embodiments discussed in connection with the method can accordingly also occur in the computer program presented here and/or the storage medium and/or the control unit, and vice versa. In this respect, reference is made in full to the statements there regarding the more detailed characterization of the features.

The solution presented here and its technical environment are explained in more detail in the following with reference to the figures. It should be noted that the invention is not intended to be limited by the exemplary embodiments shown. In particular, unless explicitly stated otherwise, it is also possible to extract partial aspects of the facts explained in the figures and to combine them with other components and/or insights from other figures and/or the present description. Shown schematically are:

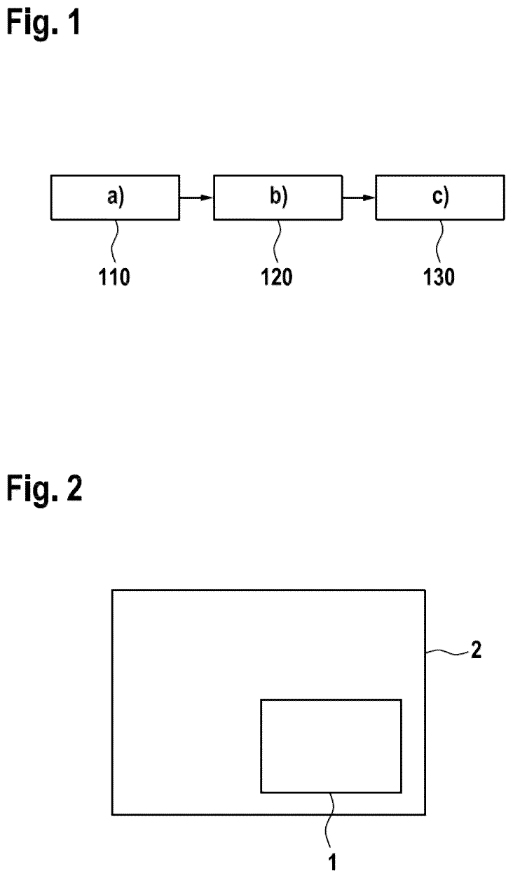

FIG. 1: an exemplary sequence of the method presented herein, and

FIG. 2: an example of a control unit described herein for a vehicle.

FIG. 1 schematically shows an exemplary sequence of the method presented herein for determining an integrity range of a parameter estimation for localization of a vehicle on the basis of obtained sensor data for localization according to surroundings features, wherein the integrity range describes the range in which an estimated parameter is located with a minimum probability. The sequence of steps a), b) and c) shown with blocks 110, 120 and 130 is an example and can, for example, be carried out at least once in the shown sequence to carry out the method.

In block 110, a base integrity information item is determined, according to step a). In block 120, at least one additional integrity information item is determined, according to step b). In block 130, the integrity range is determined using the base integrity information item and the at least one first additional integrity information item, according to step c).

FIG. 2 schematically shows an example of a control unit 1 described herein for a motor vehicle 2, the control unit 1 being configured to carry out a method described herein.

The localization may be performed according to surroundings features as positioning relative to known features in the surroundings of the vehicle. For example, the known features may be taken from a digital map of the surroundings of the vehicle. Coarse positioning of the vehicle with respect to the digital map may be performed, for example, during initialization and/or using additional sensor equipment, such as GNSS sensor equipment and/or inertial sensor equipment (for example, inertial measurement unit, or IMU).

The sensor data may preferably be obtained here from at least one environment sensor. For example, the sensor data may be obtained from a camera sensor, video sensor, radar sensor, or lidar sensor.

At least one result of the parameter estimation and the base integrity information item may be determined by a filter. For example, this data may be determined by means of a Kalman filter or particle filter. The filter may be part of a localization device of the vehicle which can transmit data to the control unit.

The base integrity information item may be determined on the basis of a mathematical model and/or may describe a stochastic measure. For example, the base integrity information item may be determined on the basis of at least one variance and/or with data of a covariance matrix. Corresponding mathematical or stochastic information may typically be provided, for example, by a Kalman filter with respect to a particular position result.

The at least one additional integrity information item may describe information about the number and/or distribution of the detectable features. In particular, the at least one additional integrity information item may describe at least one information item about the distribution of the detectable features. Advantageously, the integrity range may be determined using a stochastic measure (as the base integrity information item) and information about the distribution of the features (as the additional integrity information item).

The integrity range may be determined as a protection level. This is a particularly advantageous option for being able to use the method for modern systems for at least partially automated and/or autonomous driving.

1. A method for determining an integrity range of a parameter estimation for localization of a vehicle on the basis of obtained sensor data for localization according to surroundings features, wherein the integrity range describes the range in which an estimated parameter is located with a minimum probability, the method comprising:
a) determining a base integrity information item,
b) determining at least one additional integrity information item, and
c) determining the integrity range using the base integrity information item and the at least one additional integrity information item.

2. The method according to claim 1, wherein the localization is performed according to surroundings features as positioning relative to known features in the surroundings of the vehicle.

3. The method according to claim 1, wherein the sensor data is obtained from a camera sensor, video sensor, radar sensor, or lidar sensor.

4. The method according to claim 1, wherein at least one result of the parameter estimation and the base integrity information item are determined by a filter.

5. The method according to claim 1, wherein the base integrity information item is determined on the basis of a mathematical model and/or describes a stochastic measure.

6. The method according to claim 1, wherein the at least one additional integrity information item describes information about the number and/or distribution of the detectable features.

7. The method according to claim 1, wherein the integrity range is determined as a protection level.

8. A computer program for carrying out a method according to claim 1.

9. A machine-readable storage medium on which the computer program according to claim 8 is stored.

10. A control unit for a motor vehicle, the control unit being configured to carry out a method according to claim 1.
